(19) United States
(12) Patent Application Publication
(10) Pub. No.: US 2025/0021269 A1
(43) Pub. Date: Jan. 16, 2025

(54) PERFORMING PRECONDITIONED OPERATION BASED ON QUEUE IDENTIFIER

(71) Applicant: Micron Technology, Inc., Boise, ID (US)

(72) Inventors: Luca Bert, San Jose, CA (US); Sampath Ratnam, San Jose, CA (US)

(21) Appl. No.: 18/770,982

(22) Filed: Jul. 12, 2024

Related U.S. Application Data
(60) Provisional application No. 63/526,517, filed on Jul. 13, 2023.

(51) Int. Cl. G06F 3/06

(52) U.S. Cl. CPC G06F 3/0659; G06F 3/0613; G06F 3/0673

(57) ABSTRACT

Various embodiments provide for performing a preconditioned operation on a memory system (e.g., the memory sub-system) based on queue identifiers of command requests received from a host system, where the precondition can include detection of command requests to be performed (e.g., executed) with respect to a sequence of memory addresses.

### PRIORITY APPLICATION

This application claims the benefit of priority to U.S. Provisional Application Ser. No. 63/526,517, filed Jul. 13, 2023, which is incorporated herein by reference in its entirety.

### TECHNICAL FIELD

Embodiments of the disclosure relate generally to memory devices and, more specifically, to performing a preconditioned operation on a memory system (e.g., the memory sub-system) based on queue identifiers of command requests received from a host system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 is a block diagram illustrating an example computing system that includes a memory sub-system, in accordance with some embodiments of the present disclosure.

FIG. 2 is a diagram illustrating an example architecture of a host system and a memory sub-system, in accordance with some embodiments of the present disclosure.

FIG. 3 is a flow diagram of an example method for performing a preconditioned operation on a memory system based on queue identifiers of command requests received from a host system, in accordance with some embodiments of the present disclosure.

FIG. 4 is a flow diagram of an example method for block caching with queue identifiers, in accordance with some embodiments of the present disclosure.

FIG. 5 is a block diagram of an example computer system in which embodiments of the present disclosure may operate.

### DETAILED DESCRIPTION

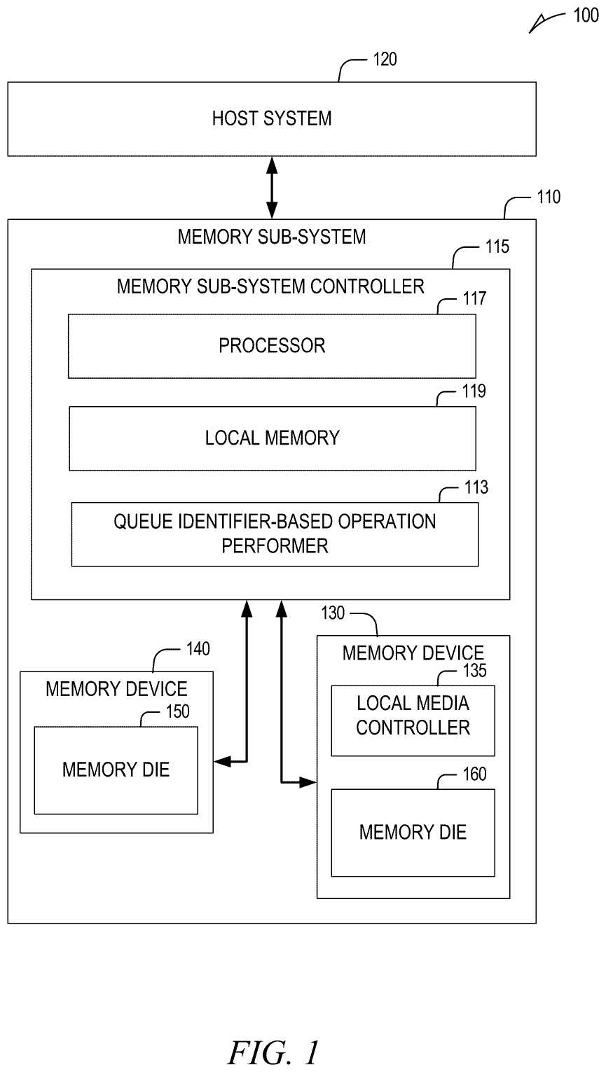

Aspects of the present disclosure are directed to performing a preconditioned operation on a memory system (e.g., the memory sub-system) based on queue identifiers of command requests received from a host system, where the precondition can include detection of command requests to be performed (e.g., executed) with respect to a sequence of memory addresses. A memory sub-system can be a storage device, a memory module, or a hybrid of a storage device and memory module. Examples of storage devices and memory modules are described below in conjunction with FIG. 1. In general, a host system can utilize a memory sub-system that includes one or more components, such as memory devices that store data. The host system can send access requests to the memory sub-system, such as to store data at the memory sub-system and to read data from the memory sub-system.

The host system can send access requests (e.g., write commands, read commands) to the memory sub-system, such as to store data on a memory device at the memory sub-system, read data from the memory device on the memory sub-system, or write/read constructs (e.g., such as submission and completion queues) with respect to a memory device on the memory sub-system. The data to be read or written, as specified by a host request (e.g., data access request or command request), is hereinafter referred to as “host data.” A host request can include logical address information (e.g., logical block address (LBA), namespace) for the host data, which is the location the host system associates with the host data. The logical address information (e.g., LBA, namespace) can be part of metadata for the host data. Metadata can also include error handling data (e.g., error-correcting code (ECC) codeword, parity code), data version (e.g., used to distinguish age of data written), valid bitmap (which LBAs or logical transfer units contain valid data), and so forth.

The memory sub-system can initiate media management operations, such as a write operation, on host data that is stored on a memory device. For example, firmware of the memory sub-system can re-write previously written host data from a location of a memory device to a new location as part of garbage collection management operations. The data that is re-written, for example as initiated by the firmware, is hereinafter referred to as “garbage collection data.”

“User data” hereinafter generally refers to host data and garbage collection data. “System data” hereinafter refers to data that is created and/or maintained by the memory sub-system for performing operations in response to host requests and for media management. Examples of system data include, and are not limited to, system tables (e.g., logical-to-physical memory address mapping table (also referred to herein as a L2P table), data from logging, scratch pad data, and so forth).

A memory device can be a non-volatile memory device. A non-volatile memory device is a package of one or more die. Each die can be comprised of one or more planes. For some types of non-volatile memory devices (e.g., NOT-AND (NAND)-type devices), each plane is comprised of a set of physical blocks. For some memory devices, blocks are the smallest area that can be erased. Each block is comprised of a set of pages. Each page is comprised of a set of memory cells, which store bits of data. The memory devices can be raw memory devices (e.g., NAND), which are managed externally, for example, by an external controller. The memory devices can be managed memory devices (e.g., managed NAND), which are raw memory devices combined with a local embedded controller for memory management within the same memory device package.

Certain memory devices, such as NAND-type memory devices, comprise one or more blocks, (e.g., multiple blocks), with each of those blocks comprising multiple memory cells. For instance, a memory device can comprise multiple pages (also referred as wordlines), with each page comprising a subset of memory cells of the memory device. Generally, writing data to such memory devices involves programming (by way of a program operation) the memory devices at the page level of a block, and erasing data from such memory devices involves erasing the memory devices at the block level (e.g., page level erasure of data is not possible).

A memory device can comprise one or more cache blocks and one or more non-cache blocks, where data written to the memory device is first written to one or more cache blocks, which can facilitate faster write performance; and data stored on the cache blocks can eventually be moved (e.g., copied) to one or more non-cache blocks at another time (e.g., a time when the memory device is idle), which can facilitate higher storage capacity on the memory device. A cache block can comprise a single-level cell (SLC) block that comprises multiple SLCs, and a non-cache block can comprise a multiple-layer cell (MLC) block that comprises multiple MLCs, a triple-level cell (TLC) block that comprises multiple TLCs, or a quad-level cell (QLC) block that comprises QLCs. Writing first to one or more SLCs blocks can be referred to as SLC write caching or SLC caching (also referred to as buffering in SLC mode). Generally, when using traditional full SLC caching, an SLC block is released of data after data is moved from the SLC block to a non-cache block (e.g., QLC block) and the non-cache block is verified to be free of errors.

A compaction (or a garbage collection) operation can be performed with respect to a cache block (containing one or more memory cells) of a memory device (e.g., NAND-type memory device), where the data stored in the cache block is copied (e.g., transferred) to a non-cache block. A compaction operation can be performed with respect to a set of cache blocks when, for instance, there are no available cache blocks to cache new data (e.g., cache new written data). As used herein, a block compaction operation is performed on a cache block and can comprise reading data stored on the cache block and writing the read data to a non-cache block (e.g., programming the non-cache block with the data read from the cache block), thereby copying the data from the cache block to the non-cache block An example block compaction operation can include a SLC-QLC block compaction operation. A block compaction operation can be performed, for instance, when available cache blocks on a memory device are full or nearing a fill limit.

For conventional memory devices that comprise NOT-AND (NAND) memory cells (hereafter referred to as NAND-type memory devices), writing and erasing sequentially generally leads to lower or reduced write amplification (e.g., a low write amplification factor (WAF)) and better data performance. While modern software on host systems (e.g., software applications, databases, and file systems) tend to read and write data sequentially with respect to a memory system (e.g., a memory sub-system coupled to a host system), when such software is executed by one or more multicore hardware processors of the host system, the sequentiality of data access request (e.g., read and write requests) to the memory system is usually lost. For instance, when modern software operates on one or more multicore hardware processors of a host system, a block layer of the host system typically divides work to be performed by each process (of the software) among two or more cores of a multicore hardware processor (e.g., in a way where work is uniformly divided across cores to achieve maximum throughput). While each core of a host system's hardware processor may still issue largely sequential data access requests to a memory system, the data access requests are usually intermingled (e.g., interleaved) with each other and appear random or pseudo-random from the perspective of the memory system. This can be due to data aggregation and request priority policy in a data link layer between the host system and the memory system. For instance, a memory system having a Non-Volatile Memory Express (NVMe) architecture is typically designed to have an out-of-order traffic handshake between the host system and a controller of the memory system for data performance reasons.

The architecture of conventional memory systems, such as those implemented by a NVMe standard, include multiple queues for processing data access requests (e.g., read and write requests) from host systems. For instance, a memory system based on a NVMe standard can comprise multiple pairs of queues, where each queue pair is associated with a different queue identifier (QID), and where each queue pair comprises a submission queue for incoming requests that need to be completed/processed and a completion queue for command requests already completed/processed by the memory system. As herein, a submission queue identifier (SQID) can refer to a submission queue of a given queue pair, and can be equal to the QID of the given queue pair. A completion queue identifier (CQID) can refer to a completion queue of a given queue pair, and can be equal to the QID of the given queue pair. A QID can be included as a parameter (e.g., QID tag) in a data access request from a host system to a memory system, and can serve as a pointer to a submission queue on the memory system that is to receive the data access request. Generally, each core of a host system's hardware processor is individually associated with (e.g., assigned to, mapped to, attached to) a different QID (e.g., different queue pair on the memory system having a unique QID), and data access requests (e.g., read and write requests) from a given core are received and stored by a submission queue that has a queue identifier associated with the given core. Additionally, a given thread executing on a host system (e.g., of a software application or a database on the host system) tends to be started/run on the same core of the host system's hardware processor (e.g., threads on the host system tend to have core affinity). A given core of a host system's hardware processor can have multiple threads (e.g., four to five threads) that operate on and have affinity to the given core.

In conventional memory systems, submission queues of a memory system can be scanned for a command request (e.g., each submission queue is scanned) and a detected command request is added to a command queue (e.g., added to an entry of the command queue) for the memory system, where the command queue stores a list of commands requests awaiting processing (e.g., execution) by the memory system. Generally, command requests are added to the command queue in the order in which command requests are retrieved from the submission queues of the memory system and, as a result, the command queue usually stores a mix of command requests associated with different queue identifiers or operating on different memory addresses. Unfortunately, this mix can make it challenging for conventional memory systems to detect when conditions are satisfied for performing certain preconditioned operations. For instance, a read-look ahead operation or a command request merging operation can be performed based on detecting multiple command requests operating on a sequence of a memory address in a command request. However, conventional memory systems can be inefficient in detecting multiple command requests operating on a sequence of a memory address in the command queue.

Aspects of the present disclosure are directed to cure these and other deficiencies of conventional memory technologies. Various embodiments provide for performing a preconditioned operation on a memory system (e.g., the memory sub-system) based on queue identifiers of command requests received from a host system, where the precondition can include detection of command requests to be performed (e.g., executed) with respect to a sequence of memory addresses. In particular, the memory system of some embodiments determines (e.g., identifies) one or more command requests in a command queue of a memory system that meet or satisfy a precondition of a preconditioned operation, and determines the one or more command requests by filtering command requests in the command queue based on at least one queue identifier associated with those command requests. Additionally, the memory system of some embodiments determines the one or more command requests by filtering command requests in the command queue based on at least one queue identifier associated with those command requests and at least one namespace identifier associated with those command requests.

By filtering based on queue identifiers, namespace identifiers, or both, a memory system of an embodiment can separate out input command streams (e.g., an input read command stream comprising multiple read command requests, or an input write command stream comprising multiple write command requests) from a host system by queue identifier, namespace identifier, or both (e.g., a given input command stream being associated with a unique combination of a queue identifier and a namespace identifier), and determine whether to perform a preconditioned operation based on a given (separate) input command stream. Overall, a memory system of an embodiment described herein can use a preconditioned operation to coalesce and process multiple command requests in the command queue (e.g., coalesce read command requests in the backend of the memory system), thereby improving performance, reducing latency (e.g., read or write latency), or both in the memory system.

As used herein, a preconditioned operation can comprise an operation that is performed based on (e.g., detection of) one or more command requests (e.g., of an input command stream) in a command queue of the memory system that satisfy one or more preconditions for a preconditioned operation. An example precondition can include one relating to a command type (e.g., read command type or a write command type), or one relating to a memory address (e.g., a pattern of memory addresses, such as a sequence of memory addresses). An example of a preconditioned operation can include an operation that is performed based on detecting a plurality of command requests of a given command type (e.g., a read command type, or a write command type) in a command queue of a memory system that are awaiting performance (e.g., execution) on a pattern (e.g., a sequence) of memory addresses (e.g., LBAs). For instance, the preconditioned operation can be a read-ahead (or read-look-ahead) operation, a merging operation (e.g., that merges multiple command requests into a single command request), or the like.

Data access request and command request are used interchangeably herein. As used herein, a data access request/command request can comprise a data access command for a memory system. Accordingly, a write request can comprise a write command for a memory system, and a read request can comprise a read command for a memory system.

As used herein, a superblock of a memory device (e.g., of a memory system) comprises a plurality (e.g., collection or grouping) of blocks of the memory device. For example, a superblock of a NAND-type memory device can comprise a plurality of blocks that share a same position in each plane in each NAND-type memory die of the NAND-type memory device.

As used herein, a namespace on a memory system (e.g., memory sub-system) can be a logical partition on the memory system for creating separate logical storage spaces on the memory system. Different portions of data storage space of a memory system can be allocated to different namespaces, and memory addresses (e.g., LBAs) within namespaces can be configured independently from each other. Accordingly, each namespace can identify a quantity of data storage space of the memory system addressable via LBA. A same LBA address can be used in different namespaces to identify different memory units (e.g., superblocks, blocks, or pages) in different portions of data storage space on the memory system. For example, a first namespace (e.g., having a first namespace identifier) can be allocated on a first portion of data storage space of a memory system and can have LBA addresses ranging from 0 to n-1, and a second namespace (e.g., having a second namespace identifier) can be allocated on a second portion of the data storage space and can have LBA addresses ranging from 0 to m-1. For various embodiments, each namespace created on a memory system can be associated with (and identified by) a unique namespace identifier. A host system can send a request to a memory system for the creation, deletion, or reservation of a namespace. After a portion of the data storage space is allocated to a namespace, an LBA address in the respective namespace can logically represent a particular memory unit on a memory device (e.g., data storage media) of the memory system. A particular memory unit logically represented by an LBA address in the namespace can physically correspond to different memory units (e.g., superblocks, blocks, or pages) at different time instances.

As used herein, a read-ahead operation (or process) can be performed to improve memory access latency, optimize data retrieval, or both. Typically, performing a read-ahead operation on a memory system involves a memory system fetching (or pre-fetching) data from one of its memory devices before it is explicitly requested by the host system (e.g., a hardware processor of the host system or a software application running on the host system). Specifically, a read-ahead operation (also referred to as a read look-ahead operation) can take advantage of spatial locality of stored data on a memory device and that a host system (e.g., a software application running thereon) has a tendency of accessing data from contiguous memory locations. The memory system can predict that once a specific memory location on a memory device is accessed (or a sequence of specific memory locations on the memory device are accessed) at the request (e.g., read request) of a host system, the host system will likely explicitly request access of data from one or more subsequent memory locations on the memory device in a sequential manner. Based on this prediction, the memory system can initiate a read-ahead operation to fetch (or pre-fetch) the data from the subsequent memory locations into a cache, buffer, or some other temporary data storage area. Subsequently, when the host system explicitly requests the fetched/pre-fetched data from the memory system (e.g., via an explicit read request), the memory system already has the requested data available in the cache or buffer, resulting in faster read access times. In this way, a read-ahead operation can reduce or help reduce read access latency.

Disclosed herein are some examples of performing a preconditioned operation on a memory system (e.g., the memory sub-system) based on queue identifiers of command requests received from a host system, as described herein.

FIG. 1 illustrates an example computing system 100 that includes a memory sub-system 110, in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, a secure digital (SD) card, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-systems 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, and the like.

The host system 120 can include a processor chipset and a software stack executed by the processor chipset. The processor chipset can include one or more cores, one or more caches, a memory controller (e.g., NVDIMM controller), and a storage protocol controller (e.g., a peripheral component interconnect express (PCIe) controller, serial advanced technology attachment (SATA) controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a SATA interface, a peripheral component interconnect express (PCIe) interface, USB interface, Fibre Channel, Serial Attached SCSI (SAS), Small Computer System Interface (SCSI), a double data rate (DDR) memory bus, a DIMM interface (e.g., DIMM socket interface that supports DDR), Open NAND Flash Interface (ONFI), DDR, Low Power Double Data Rate (LPDDR), or any other interface. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the PCIe interface. The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random-access memory (DRAM) and synchronous dynamic random-access memory (SDRAM).

Some examples of non-volatile memory devices (e.g., memory device 130) include a NAND type flash memory and write-in-place memory, such as a three-dimensional (3D) cross-point memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional (2D) NAND and 3D NAND.

Each of the memory devices 130 can include one or more arrays of memory cells. One type of memory cell, for example, SLCs, can store one bit per cell. Other types of memory cells, such as MLCs, TLCs, QLCs, and penta-level cells (PLCs), can store multiple or fractional bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, or a QLC portion of memory cells. The memory cells of the memory devices 130 can be grouped as pages that can refer to a logical unit of the memory device used to store data. With some types of memory (e.g., NAND), pages can be grouped to form blocks.

As used herein, a block comprising SLCs can be referred to as a SLC block, a block comprising MLCs can be referred to as a MLC block, a block comprising TLCs can be referred to as a TLC block, and a block comprising QLCs can be referred to as a QLC block.

Although non-volatile memory components such as NAND type flash memory (e.g., 2D NAND, 3D NAND) and 3D cross-point array of non-volatile memory cells are described, the memory device 130 can be based on any other type of non-volatile memory, such as read-only memory (ROM), phase change memory (PCM), self-selecting memory, other chalcogenide-based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide-based RRAM (OxRAM), negative-or (NOR) flash memory, and electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor (processing device) 117 configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, and so forth. The local memory 119 can also include ROM for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands, requests, or operations from the host system 120 and can convert the commands, requests, or operations into instructions or appropriate commands to achieve the desired access to the memory devices 130 and/or the memory device 140. The memory sub-system controller 115 can be responsible for other operations such as wear leveling operations, garbage collection operations, error detection and ECC operations, encryption operations, caching operations, and address translations between a logical address (e.g., LBA, namespace) and a physical memory address (e.g., physical block address) that are associated with the memory devices 130. The memory sub-system controller 115 can further include host interface circuitry to communicate with the host system 120 via the physical host interface. The host interface circuitry can convert the commands received from the host system 120 into command instructions to access the memory devices 130 and/or the memory device 140 as well as convert responses associated with the memory devices 130 and/or the memory device 140 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, a memory device 130 is a managed memory device, which is a raw memory device combined with a local controller (e.g., local media controller 135) for media management within the same memory device package. An example of a managed memory device is a managed NAND (MNAND) device.

Each of the memory devices 130, 140 include a memory die 150, 160. For some embodiments, each of the memory devices 130, 140 represents a memory device that comprises a printed circuit board, upon which its respective memory die 150, 160 is solder mounted.

The memory sub-system controller 115 includes a queue identifier-based operation performer 113 that enables or facilitates the memory sub-system controller 115 to perform a preconditioned operation on the memory sub-system 110 as described herein. For some embodiments, the queue identifier-based operation performer 113 can be part of a larger queue identifier-based request processor (not shown). Alternatively, some or all of the queue identifier-based operation performer 113 is included by the local media controller 135, thereby enabling the local media controller 135 to enable or facilitate performance of a preconditioned operation on the memory sub-system 110 as described herein.

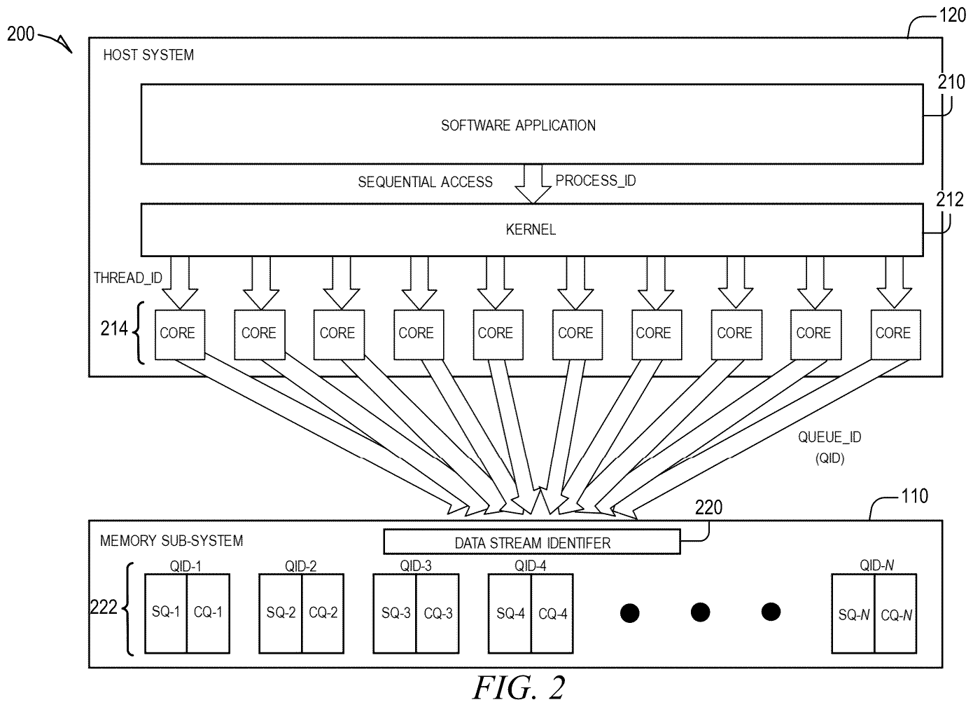

FIG. 2 is a diagram illustrating an example architecture 200 of the host system 120 and the memory sub-system 110 of FIG. 1, in accordance with some embodiments of the present disclosure. In the example architecture 200, the host system 120 comprises multiple hardware processor cores 214, a software application 210 operating on the multiple hardware processor cores 214, and a kernel 212 (e.g., of an operating system) operating on the multiple hardware processor cores 214. Additionally, in the example architecture 200, the memory sub-system 110 comprises a data stream identifier 220 (e.g., which is part of a queue identifier-based request processor) and multiple pairs of queues 222, which include queues pairs associated with queue identifier-1 (QID-1) through queue identifier-N (QID-N). The queue pair associated with queue identifier-1 (QID-1) comprises a submission queue 1 (SQ-1) and a completion queue (CQ-1), the queue pair associated with queue identifier-2 (QID-2) comprises a submission queue-2 (SQ-2) and a completion queue (CQ-2), the queue pair associated with queue identifier-3 (QID-3) comprises a submission queue-3 (SQ-3) and a completion queue (CQ-3), the queue pair associated with queue identifier-4 (QID-4) comprises a submission queue-4 (SQ-4) and a completion queue (CQ-4), and so on. During operation, the software application 210 can cause execution of processes (having process identifiers (PROCESS_IDs)) by the kernel 212, where one or more of the processes can involve generation of sequential data access requests. The kernel 212 can execute at least one of the processes by dividing the process into multiple threads (each having a thread identifier (THREAD_ID)) to be executed by the multiple hardware processor cores 214. Each of the threads can be assigned for execution by one of the multiple hardware processor cores 214 (e.g., according to core affinity), and execution of a thread by a given hardware processor core can cause the given hardware processor core to generate and issue one or more data access requests to the memory sub-system 110, where each generated/issued data access request includes a queue identifier (QID) of the given hardware processor core.

As data access requests are generated and issued by the multiple hardware processor cores 214, the data access requests from each hardware processor core can be interleaved with those generated and issued by one or more other hardware processor cores. Accordingly, the data access request received by the memory sub-system 110 can appear random or pseudo-random to the memory sub-system 110.

Upon receiving a given data access request, the memory sub-system 110 can use the data stream identifier 220 to determine a given queue identifier of the given data access request, and the memory sub-system 110 can cause the given data access request to be stored in a submission queue (e.g., stored to an entry added to the submission queue) of the queue pair (of the multiple pairs of queues 222) that corresponds to (e.g., matches) the given queue identifier. When the given data access request has been processed (e.g., executed) by the memory sub-system 110, the results of the given data access request can be stored (e.g., queued) to a completion queue (e.g., stored to an entry added to the completion queue) of the queue pair (of the multiple pairs of queues 222) that corresponds to (e.g., matches) the given queue identifier, from which the host system 120 can obtain (e.g., collect) the results.

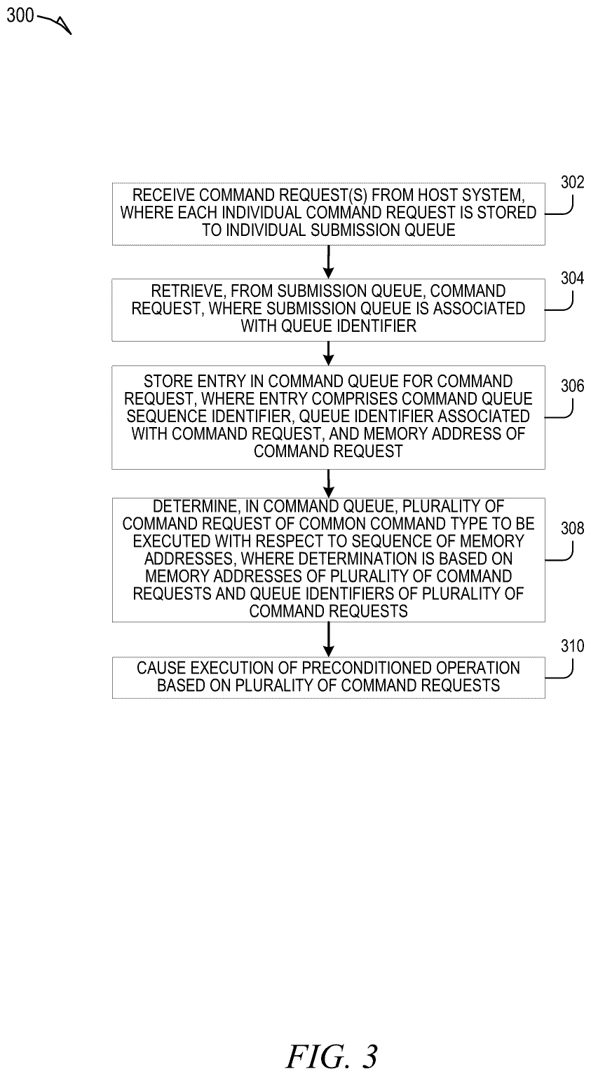

FIG. 3 is a flow diagram of an example method 300 for performing a preconditioned operation on a memory system based on queue identifiers of command requests received from a host system, in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the memory sub-system controller 115 of FIG. 1 based on the queue identifier-based operation performer 113. Additionally, or alternatively, for some embodiments, the method 300 is performed, at least in part, by the local media controller 135 of the memory device 130 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are used in every embodiment. Other process flows are possible.

Referring now to the method 300 of FIG. 3, at operation 302, a processing device (e.g., the processor 117 of the memory sub-system controller 115) receives a set of command requests from a host system (e.g., 120), where each individual command request in the set of command requests is stored to an individual submission queue of a memory system (e.g., the memory sub-system 110) associated with (e.g., that corresponds to) an individual queue identifier of the individual command request. For some embodiments, a command request received from the host system comprises a queue identifier (e.g., includes a QID tag) associated with the command request (e.g., based on the host-side submission queue from which the command request was sent).

Subsequently, at operation 304, the processing device (e.g., the processor 117) retrieves, from one of a submission queue of the plurality of submission queues of the memory system (e.g., the memory sub-system 110), a command request (e.g., a read request or a write request) for the memory system, where the submission queue is associated with a queue identifier. For some embodiments, operation 304 is performed as part of the processing device (e.g., the processor 117) scanning one or more submission queues (e.g., scan each submission queue) of the memory system (e.g., the memory sub-system 110) for command requests to be executed.

At operation 306, the processing device (e.g., the processor 117) stores an entry for a command request in a command queue of the memory system, where the entry comprises a command queue sequence identifier, the queue identifier associated with the command request, and a memory address of the command request (e.g., the memory address upon which the command request is operating). For some embodiments, the entry comprises a command type of the command request. The command type can include a read command type or a write command type. The entry can further comprise a data size (e.g., block size) for the command request, and a command identifier associated with the command request, which the host system can use to uniquely identify the command request. The memory address can comprise a LBA, and the memory address can correspond to a memory location (e.g., superblock, block, or a page) on a memory device of the memory system.

During operation 308, the processing device (e.g., the processor 117) determines (e.g., identifies), in the command queue, a plurality of command requests of a common command type (e.g., read command type or write command type) to be executed with respect to a sequence of memory addresses, where the plurality of command requests is determined based on memory addresses of the plurality of command requests and queue identifiers (e.g., submission queue identifiers, SQIDs) of the plurality of command requests. For instance, the processing device can determine (e.g., identify), within the command queue, multiple read requests associated with a single common queue identifier (e.g., a single common SQID) and operating on a sequence of memory addresses, and can do so even if the multiple read requests are interspersed within the command queue. Accordingly, in the command queue, there can be two or more sub-sequences of entries that correspond to the plurality of command requests determined by operation 308. For various embodiments, the queue identifier used during operation 308 to determine the plurality of command requests is the submission queue identifier (SQID) associated with individual command requests in the command queue. For some embodiments, operation 308 comprises filtering command requests in the command queue based on at least one queue identifier (e.g., at least one SQID). For example, the processing device can filter command requests in the command queue based on a single queue identifier (e.g., QID #5) and a single command type (e.g., read command type), thereby identifying multiple command requests of a common command type that are commonly associated with the single queue identifier. For some embodiments, the entry comprises a namespace identifier associated with the command request, where the namespace identifier corresponds to a namespace created on the memory system. Accordingly, at operation 308, the processing device can determine the plurality of command requests based on memory addresses of the plurality of command requests, the queue identifiers of the plurality of command requests, and namespace identifiers of the plurality of command requests. For instance, the processing device can determine (e.g., identify), within the command queue, multiple read requests associated with a single common queue identifier, a single common namespace identifier, and operating on a sequence of memory addresses, and can do so even if the multiple read requests are interspersed within the command queue. For some embodiments, operation 308 comprises filtering command requests in the command queue based on at least one queue identifier and at least one namespace identifier. For example, the processing device can filter command requests in the command queue based on a single queue identifier (e.g., QID #5), a single namespace identifier (e.g., name space ID #2) and a single command type (e.g., read command type), thereby identifying multiple command requests of a common command type that are commonly associated with the combination of the single queue identifier and the single namespace identifier. By filtering the command queue based on (e.g., by) a queue identifier, a namespace identifier, or both, a memory system of some embodiments can determine (e.g., identify) at least one plurality of command requests in the command queue that satisfies one or more preconditions for performing a preconditioned operation, such as a sequence of memory addresses being operated on by command requests of a common command type.

Thereafter, at operation 310, the processing device (e.g., the processor 117) causes execution of a preconditioned operation based on the plurality of command requests determined (e.g., identified) by operation 308. For some embodiments, the preconditioned operation the common command type of the plurality of command requests (determined by operation 308) is a read command type (e.g., the plurality of command requests is a plurality of read requests), and the preconditioned operation comprises a read-ahead operation configured to prefetch stored data from a set of memory addresses (e.g., a second sequence of memory addresses corresponding to a second sequence of memory locations on the memory system) based on the (first) sequence of memory addresses of the plurality of command requests. The set of memory addresses can be determined by the read-ahead operation based on one or more factors traditionally considered by read-ahead operations. Additionally, for some embodiments, the preconditioned operation comprises a merging operation configured to merge the plurality of command requests into a single command request to be executed on the sequence of memory addresses. For example, the common command type can comprise a read command type (the plurality of command requests is a plurality of read requests), and each read request in the plurality of write requests is configured to read from its respective memory address. In such a case, the plurality of read requests can be merged into a single read request configured to read stored data from a range of memory addresses that corresponds to the sequence of memory addresses. Similarly, the common command type can comprise a write command type (the plurality of command requests is a plurality of write requests), and each write request in the plurality of write requests is configured to write a full block of its respective data to its respective memory address. In such a case, the merge operation can merge the plurality of write requests into a single write request configured to write the respective data across a range of memory addresses that corresponds to the sequence of memory addresses.

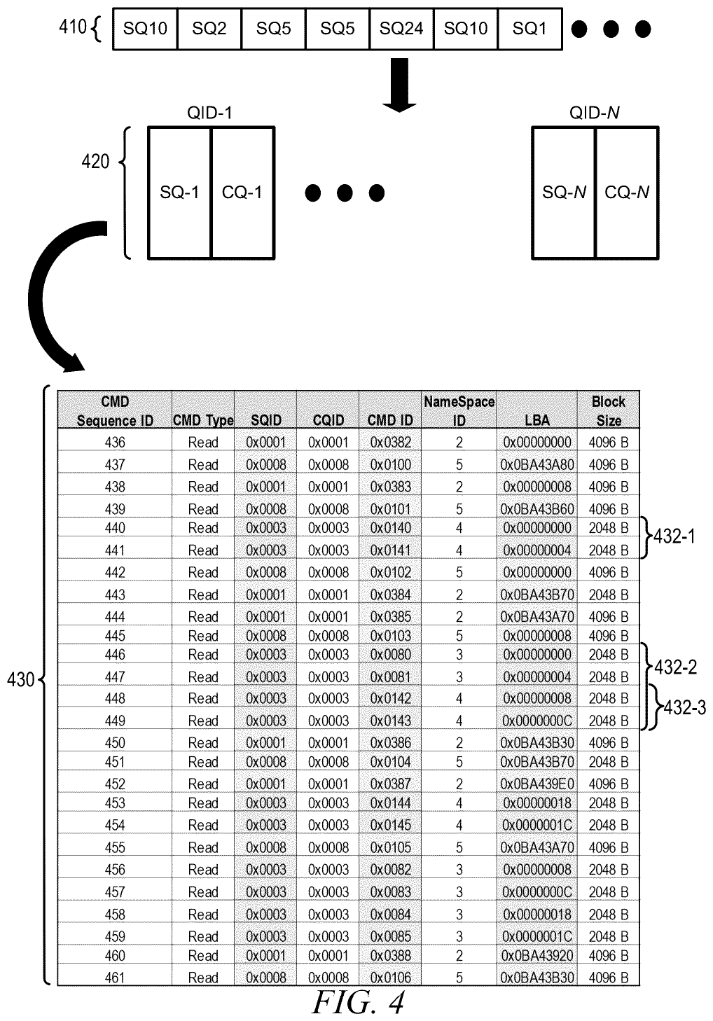

FIG. 4 is a flow diagram of an example method for block caching with queue identifiers, in accordance with some embodiments of the present disclosure. In particular, FIG. 4 illustrates a command stream 410, a plurality of queue pairs 420 of a memory system (e.g., the memory sub-system 110), and a command queue 430 of the memory system. As shown, as the command stream 410 flows into the memory system, a command request (e.g., read request or write request) from the command stream 410 is stored to a submission queue (e.g., SQ-4) of one of the queue pairs (of the plurality of queue pairs 420) associated with the queue identifier (e.g., QID-4) of the command request. As the memory system scans submission queues of the plurality of queue pairs 420 for command requests (e.g., each submission queue is scanned for a new command request), the memory system can retrieve a detected command request from one of the submission queues and add the detected command request to the command queue 430 (e.g., added to an entry of the command queue). The command queue 430 can serve as a central queue for processing (e.g., executing) command requests within the memory system. An entry for a given command request in the command queue 430 includes information describing: a command sequence identifier (CMD Sequence ID); a command type (CMD Type); a submission queue identifier (SQID); a completion queue identifier (CQID); a command identifier (CMD ID); a namespace identifier (NameSpace ID); a memory address (e.g., LBA); and a data size of the command (e.g., block size). The SQID and CQID of an entry typically have the same value. The SQID corresponds to a submission queue (of the plurality of queue pairs 420) through which the given command request was received by the memory system, and the CQID corresponds to a completion queue (of the plurality of queue pairs 420) through which the results of the given command request are to be passed back to a host system (e.g., 120). The CMD ID can be an identifier provided with (e.g., included in) the given command request when it is received from the host system, and can be used to uniquely identify the given command request within the memory system, the host system, or both. For instance, the CMD ID can be included with an entry added to the completion queue for the given command request so that the host system can match the result with the given command request. The NameSpace ID can identify the namespace in which the given command request is operating, and the memory address (e.g., LBA) can correspond to a memory location of the memory system upon which the given command request is to be processed (e.g., executed). For some embodiments, the identified namespace determines to which memory location the memory address corresponds.

During operation of an embodiment, the memory system can analyze the command queue 430 and identify command requests that satisfy the following preconditions: have a common command type; and operating on a sequence of memory addresses. To do so, the memory system can filter the command queue 430 based on (e.g., by) a single submission queue identifier, a single namespace identifier, or both. For instance, by filtering the command queue 430 for read requests associated with the SQID of 0x0003, the memory system can determine that a first set (e.g., sub-sequence) of entries 432-1 and a second set (e.g., sub-sequence) of entries 432-2 are operating on a sequence of memory addresses (e.g., LBAs 0x00000000, 0x00000004, 0x00000008, 0x0000000C). In response, the memory system can perform a preconditioned operation, such as a read-ahead operation or a merge operation, based on the sequence of memory addresses formed by the first and second sets of entries 432-1, 432-2. In another instance, if the memory system filtered the command queue 430 for read requests associated with the SQID of 0x0003 and a NameSpace ID of 4, the memory system can determine that a first set (e.g., sub-sequence) of entries 432-1 and a third set (e.g., sub-sequence) of entries 432-3 are operating on a sequence of memory addresses (e.g., LBAs 0x00000000, 0x00000004, 0x00000008, 0x0000000C). In response, the memory system can perform a preconditioned operation, such as a read-ahead operation or a merge operation, based on the sequence of memory addresses formed by the first and third sets of entries 432-1, 432-3. While FIG. 4 illustrates detection of a precondition of memory address sequentiality, it will be appreciated that for some embodiments, other preconditions can be detected for prior to execution of a relevant preconditioned operation.

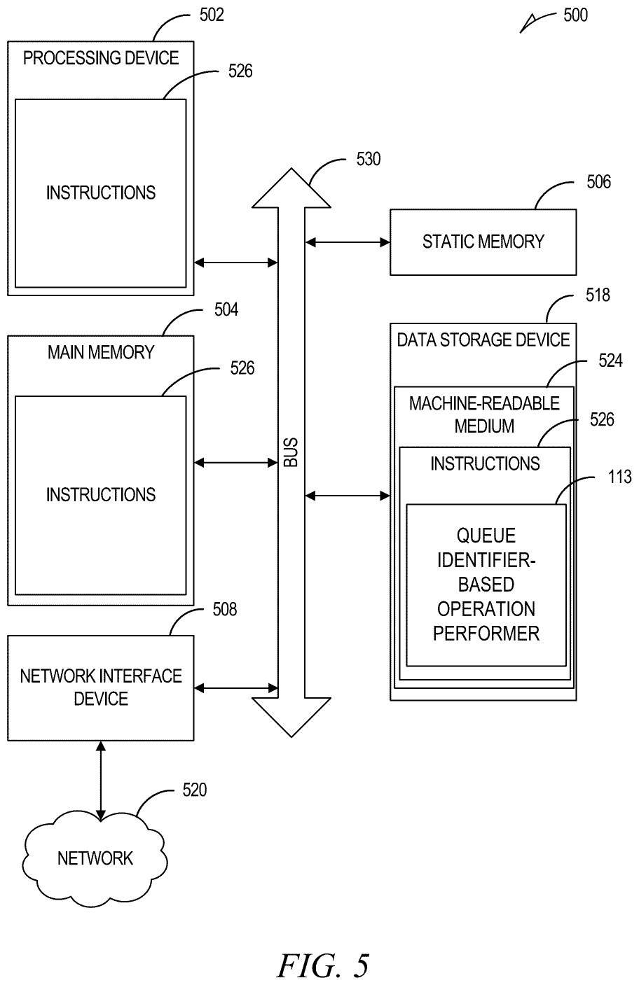

FIG. 5 illustrates an example machine in the form of a computer system 500 within which a set of instructions can be executed for causing the machine to perform any one or more of the methodologies discussed herein. In some embodiments, the computer system 500 can correspond to a host system (e.g., the host system 120 of FIG. 1) that includes, is coupled to, or utilizes a memory sub-system (e.g., the memory sub-system 110 of FIG. 1) or can be used to perform the operations described herein. In alternative embodiments, the machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., ROM, flash memory, DRAM such as SDRAM or Rambus DRAM (RDRAM), etc.), a static memory 506 (e.g., flash memory, static random access memory (SRAM), etc.), and a data storage device 518, which communicate with each other via a bus 530.

The processing device 502 represents one or more general-purpose processing devices such as a microprocessor, a central processing unit, or the like. More particularly, the processing device 502 can be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 502 can also be one or more special-purpose processing devices such as an application-specific integrated circuit (ASIC), a field programmable gate array (FPGA), a digital signal processor (DSP), a network processor, or the like. The processing device 502 is configured to execute instructions 526 for performing the operations and steps discussed herein. The computer system 500 can further include a network interface device 508 to communicate over a network 520.

The data storage device 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage device 518, and/or main memory 504 can correspond to the memory sub-system 110 of FIG. 1.

In one embodiment, the instructions 526 include instructions to implement functionality corresponding to performing one or more data read-ahead operations on the memory sub-system 110 as described herein (e.g., the queue identifier-based operation performer 113 of FIG. 1). While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer-readable storage medium, such as, but not limited to, any type of disk including floppy disks, optical disks, CD-ROMs, and magnetic-optical disks, ROMs, RAMs, EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium (e.g., non-transitory machine-readable medium) having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a ROM, RAM, magnetic disk storage media, optical storage media, flash memory components, and so forth.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a plurality of submission queues configured to receive command requests from a host system;
a command queue configured to store command requests awaiting execution on the system;
a memory device; and
a processing device, operatively coupled to the memory device, configured to perform operations comprising:
retrieving, from a submission queue of the plurality of queues, a command request, the submission queue being associated with a queue identifier;
storing an entry for the command request in the command queue, the entry comprising a command queue sequence identifier, the queue identifier associated with the command request, and a memory address of the command request, the memory address corresponding to a memory location on the memory device;
determining, in the command queue, a plurality of command requests of a common command type to be executed with respect to a sequence of memory addresses, the determining being based on memory addresses of the plurality of command requests and queue identifiers of the plurality of command requests; and
causing execution of a preconditioned operation based on the plurality of command requests.

2. The system of claim 1, wherein the determining of the plurality of command requests comprises filtering command requests in the command queue based on at least one queue identifier.

3. The system of claim 1, wherein the plurality of command requests corresponds to two or more sub-sequences of entries in the command queue.

4. The system of claim 1, wherein the queue identifiers of the plurality of command requests comprise a single queue identifier.

5. The system of claim 1, wherein the common command type is a read command type, and wherein the preconditioned operation comprises a read-ahead operation configured to prefetch stored data from a set of memory addresses based on the sequence of memory addresses.

6. The system of claim 5, wherein the sequence of memory addresses is a first sequence of memory addresses, and wherein the set of memory addresses comprises a second sequence of memory addresses.

7. The system of claim 1, wherein the preconditioned operation comprises a merging operation configured to merge the plurality of command requests into a single command request to be executed on the sequence of memory addresses.

8. The system of claim 7, wherein the common command type is a read command type.

9. The system of claim 1, wherein the entry comprises a namespace identifier associated with the command request, and wherein the plurality of command requests is determined based on memory addresses of the plurality of command requests, the queue identifiers of the plurality of command requests, and namespace identifiers of the plurality of command requests.

10. The system of claim 9, wherein the determining of the plurality of command requests comprises filtering command requests in the command queue based on at least one queue identifier and at least one namespace identifier.

11. The system of claim 9, wherein the namespace identifiers of the plurality of command requests comprise a single namespace identifier.

12. The system of claim 1, wherein the submission queue is a select submission queue, wherein the queue identifier is a select queue identifier, and wherein the operations comprise:
receiving a set of command requests from the host system, each individual command request in the set of command requests including an individual queue identifier, the individual command request being stored to an individual submission queue of the plurality of submission queues, the individual submission queue associated with the individual queue identifier.

13. At least one non-transitory machine-readable storage medium comprising instructions that, when executed by a processing device of a memory sub-system, cause the processing device to perform operations comprising:
retrieving, from a submission queue of the memory sub-system, a command request, the submission queue being associated with a queue identifier;
storing an entry for the command request in a command queue of the memory sub-system, the entry comprising a command queue sequence identifier, the queue identifier associated with the command request, and a memory address of the command request, the memory address corresponding to a memory location on the memory sub-system;
determining, in the command queue, a plurality of command requests of a common command type to be executed with respect to a sequence of memory addresses, the determining being based on memory addresses of the plurality of command requests and queue identifiers of the plurality of command requests; and
causing execution of a preconditioned operation based on the plurality of command requests.

14. The at least one non-transitory machine-readable storage medium of claim 13, wherein the determining of the plurality of command requests comprises filtering command requests in the command queue based on at least one queue identifier.

15. The at least one non-transitory machine-readable storage medium of claim 13, wherein the plurality of command requests corresponds to two or more sub-sequences of entries in the command queue.

16. The at least one non-transitory machine-readable storage medium of claim 13, wherein the queue identifiers of the plurality of command requests comprise a single queue identifier.

17. The at least one non-transitory machine-readable storage medium of claim 13, wherein the common command type is a read command type, and wherein the preconditioned operation comprises a read-ahead operation configured to prefetch stored data from a set of memory addresses based on the sequence of memory addresses.

18. The at least one non-transitory machine-readable storage medium of claim 13, wherein the preconditioned operation comprises a merging operation configured to merge the plurality of command requests into a single command request to be executed on the sequence of memory addresses.

19. The at least one non-transitory machine-readable storage medium of claim 13, wherein the entry comprises a namespace identifier associated with the command request, and wherein the plurality of command requests is determined based on memory addresses of the plurality of command requests, the queue identifiers of the plurality of command requests, and namespace identifiers of the plurality of command requests.

20. A method comprising:
retrieving, by a processing device of a memory sub-system and from a submission queue of the memory sub-system, a command request, the submission queue being associated with a queue identifier;
storing, by the processing device, an entry for the command request in a command queue of the memory sub-system, the entry comprising a command queue sequence identifier, the queue identifier associated with the command request, and a memory address of the command request, the memory address corresponding to a memory location on the memory sub-system;
determining, by the processing device and in the command queue, a plurality of command requests of a common command type to be executed with respect to a sequence of memory addresses, the determining being based on memory addresses of the plurality of command requests and queue identifiers of the plurality of command requests; and
causing, by the processing device, execution of a preconditioned operation based on the plurality of command requests.
